(19) United States
(12) Patent Application Publication
(10) Pub. No.: US 2006/0173877 A1
(43) Pub. Date: Aug. 3, 2006

(54) Automated alerts for resource retention problems

(76) Inventors: Piotr Findeisen, Plano, TX (US); David Isaiah Seidman, Sunnyvale, CA (US); Joseph Coha, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/032,384

(22) Filed: Jan. 10, 2005

(51) Int. Cl. G06F 7/00; G06F 17/00

(52) U.S. Cl. 707/101

(57) ABSTRACT

One embodiment disclosed relates to a method of automated alerts for resource retention problems. Data on the resource usage as a function of time is obtained, and an automated analysis of the resource usage data is performed to determine whether the data indicates a minimum level of retention of the resource that increases over time for a period of time longer than a threshold time period. An alert notification is provided if the analysis determines that said indication is inferred from the data. Other embodiments are also disclosed.

### BACKGROUND OF THE INVENTION

1. Field of the Invention

The present invention relates generally to computer systems.

2. Description of the Background Art

Undesired Retention of Limited Resources

One of the issues involved in information processing on computer systems is the undesired retention of limited resources by computer programs, such as applications or operating systems. Typically, a computer system is comprised of limited resources, regardless of whether the resources are physical, virtual, or abstract. Examples of such resources are memory, disk space, file descriptors, socket port numbers, database connections or other entities that are manipulated by computer programs.

A computer program may dynamically allocate resources for its exclusive use during its execution. When a resource is no longer needed, it may be released by the program. Releasing the resource can be done by an explicit action performed by the program, or by an automatic resource management system.

Memory Leaks

As mentioned above, one example of a managed resource is memory in a computer system that may be allocated to programs at runtime. In other words, this portion of memory is dynamically managed. The entity that dynamically manages memory is usually referred to as a memory manager, and the memory managed by the memory manager is often referred to as a memory “heap.” Blocks of the memory heap may be allocated temporarily to a specific program and then freed when no longer needed by the program. Free blocks are available for re-allocation.

In some programming languages, such as C and C++ and others, the memory manager functionality is typically provided by the application program itself. Any release of unneeded memory is controlled by the programmer. Failure to explicitly release unneeded memory results in memory being wasted, as it will not be used by this or any other program. Program errors which lead to such wasted memory are often called “memory leaks.”

In other programming languages, such as Java, Eiffel, C sharp (C#) and others, automatic memory management is employed, rather than explicit memory release. Automatic memory management, popularly known in the art as “garbage collection,” is an active component of the runtime system associated with the implementation of these programming languages. The automatic memory management removes unneeded chunks of allocated memory, also known as objects, from the heap during the application execution. An object is unneeded if the application can no longer use it during its execution.

A frequent problem appearing in applications written in languages with automatic memory management is that some objects remain live despite being no longer needed and often contrary to the programmer's intentions. This is typically caused by either design or coding errors within the application program, but it may also be caused by shortcomings in the garbage collector. Such objects are referred to as retained or “lingering objects”, or sometimes also as “memory leaks.”

Regardless of whether the language runtime has automatic memory management, memory leaks accumulate wasted memory over time. This unnecessarily builds up the heap and causes various performance problems. It may eventually lead to an application that is no longer able to make efficient forward progress, often followed by a premature application termination when memory is finally exhausted.

It is useful and advantageous, particularly in production environments, to detect and be alerted to the presence of memory leaks at an early time, before an application reaches an unstable state. Early detection and notification of memory leaks gives the operations staff choices, such as a graceful application shutdown, or other contingency actions. Catching such problems early may be particularly useful in environments striving for automatic management of the entire computing infrastructure.

Prior attempts have been made to deal with the problem of detecting memory leaks. Some of these prior attempts are now discussed.

To detect memory leaks or lingering objects, programmers in the development phase of the application life-cycle typically employ memory debugging or memory profiling tools. However, such tools are often unusable in a production environment (i.e., when the application is deployed) because these tools are usually too performance or memory intrusive and may require an application to re-start.

A second type of tool, designed for monitoring applications in the production environment, is able to detect and present changes in the size of the heap over time. Using such a tool, the operator can observe the behavior of the heap and use his or her best judgment to deduce that a possible memory leakage problem has affected the monitored application.

A third type of tool may alert an operator in a production environment when the level of an available resource reaches a dangerously low condition. For example, such a tool may utilize a simple threshold and provide an alert or alarm when the available resource (for example, free memory) goes below that pre-defined threshold. A difficulty with this type of tool is determining a threshold value that gives sufficient advance warning to the operator without being overly conservative. An overly conservative threshold may flood the operator with false alarms, for example, when the resource usage pattern is spiky.

A fourth type of tool, also designed for production environment, collects information about the allocation and lifetime of selected objects in the heap. Such tools may employ code instrumentation in the application code and/or libraries to collect the information. These tools typically do not cover all situations because they make assumptions about the heap structure of the specific runtime environment and because their code instrumentation is selective. These tools also introduce undesirable overhead to the monitored application. As such, there is a trade-off between the information they collect and their level of intrusion.

### SUMMARY

One embodiment of the invention relates to a method of automated alerts for resource retention problems. Data on the resource usage is obtained as a function of time, and an automated analysis of the resource usage data is performed to determine whether the data indicates a minimum level of retention of the resource that increases over time for a period of time longer than a threshold time period. An alert notification is provided if the analysis determines that said indication is inferred from the data.

Another embodiment of the invention relates to an apparatus providing automated alerts for resource retention problems. Computer-readable code of the apparatus is configured to obtain data on the resource usage as a function of time, and to perform an automated analysis of the resource usage data to determine whether the data indicates a minimum level of retention of the resource that increases over time for a period of time longer than a threshold time period. An alert notification is provided if the analysis determines that said indication is present in the data.

Other embodiments of the invention are also disclosed.

### BRIEF DESCRIPTION OF THE DRAWINGS

FIG. 1 is a schematic diagram of an exemplary computer system in the context of which an embodiment of the invention may be implemented.

FIG. 2 is a flow chart depicting an exemplary process for periodically measuring a resource usage level and storing the data in accordance with an embodiment of the invention.

FIG. 3 is a flow chart depicting an exemplary method of generating an automated alert regarding a resource retention problem in accordance with an embodiment of the invention.

FIG. 4 is a chart depicting a hypothetical resource usage function h(t) over a set of times T that is analyzed to determine the linear function l(t) in accordance with an embodiment of the invention.

### DETAILED DESCRIPTION

The following detailed description focuses primarily on embodiments of the invention where the resource being managed is a memory heap that may be allocated at runtime to programs. However, the scope of the invention is not necessarily limited to memory management. Other embodiments of the invention may be used in relation to the undesirable retention of other available resources in computer systems or in other environments, so long as the level of the available resource may be counted or measured. Other available resources in a computer system to which embodiments of the present invention may be applied include, for example, data storage space in a hard disk or other data storage system, file descriptors, socket port numbers, database connections, or other entities that are manipulated by computer programs.

### EXEMPLARY EMBODIMENTS OF THE INVENTION

In accordance with an embodiment of the invention, the aforementioned problems and limitations are overcome with an automated low-intrusion technique for detecting undesired resource retention. The technique is discussed in detail in relation to memory management in a computer system, but the technique may also be applied to other resource usage problems in computer systems or other systems.

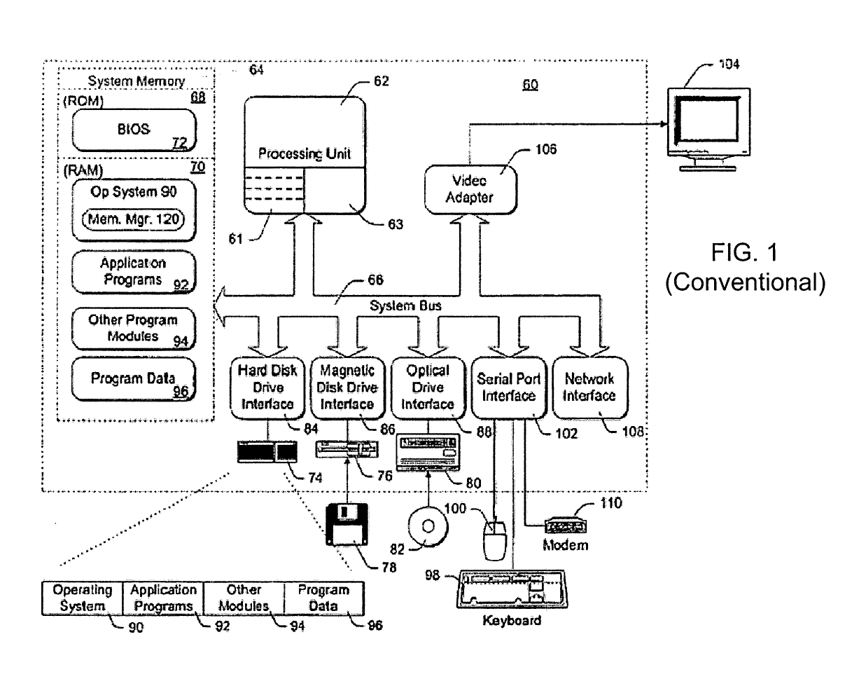

An embodiment of the invention may be implemented in the context of a computer system, such as, for example, the computer system 60 depicted in FIG. 1. Other embodiments of the invention may be implemented in the context of different types of computer systems or other systems.

The computer system 60 may be configured with a processing unit 62, a system memory 64, and a system bus 66 that couples various system components together, including the system memory 64 to the processing unit 62. The system bus 66 may be any of several types of bus structures including a memory bus or memory controller, a peripheral bus, and a local bus using any of a variety of bus architectures.

Processor 62 typically includes cache circuitry 61, which includes cache memories having cache lines, and pre-fetch circuitry 63. The processor 62, the cache circuitry 61 and the pre-fetch circuitry 63 operate with each other as known in the art. The system memory 64 includes read only memory (ROM) 68 and random access memory (RAM) 70. A basic input/output system 72 (BIOS) is stored in ROM 68.

The computer system 60 may also be configured with one or more of the following drives: a hard disk drive 74 for reading from and writing to a hard disk, a magnetic disk drive 76 for reading from or writing to a removable magnetic disk 78, and an optical disk drive 80 for reading from or writing to a removable optical disk 82 such as a CD ROM or other optical media. The hard disk drive 74, magnetic disk drive 76, and optical disk drive 80 may be connected to the system bus 66 by a hard disk drive interface 84, a magnetic disk drive interface 86, and an optical drive interface 88, respectively. The drives and their associated computer-readable media provide nonvolatile storage of computer readable instructions, data structures, program modules and other data for the computer system 60. Other forms of data storage may also be used.

A number of program modules may be stored on the hard disk, magnetic disk 78, optical disk 82, ROM 68, and/or RAM 70. These programs include an operating system 90, one or more application programs 92, other program modules 94, and program data 96. A user may enter commands and information into the computer system 60 through input devices such as a keyboard 98 and a mouse 100 or other input devices. These and other input devices are often connected to the processing unit 62 through a serial port interface 102 that is coupled to the system bus 66, but may be connected by other interfaces, such as a parallel port, game port, or a universal serial bus (USB). A monitor 104 or other type of display device may also be connected to the system bus 66 via an interface, such as a video adapter 106. In addition to the monitor, personal computers typically include other peripheral output devices (not shown) such as speakers and printers. The computer system 60 may also have a network interface or adapter 108, a modem 110, or other means for establishing communications over a network (e.g., LAN, Internet, etc.).

The operating system 90 may be configured with a memory manager 120. The memory manager 120 may be configured to handle allocations, reallocations, and deallocations of RAM 70 for one or more application programs 92, other program modules 94, or internal kernel operations. The memory manager may be tasked with dividing memory resources among these executables.

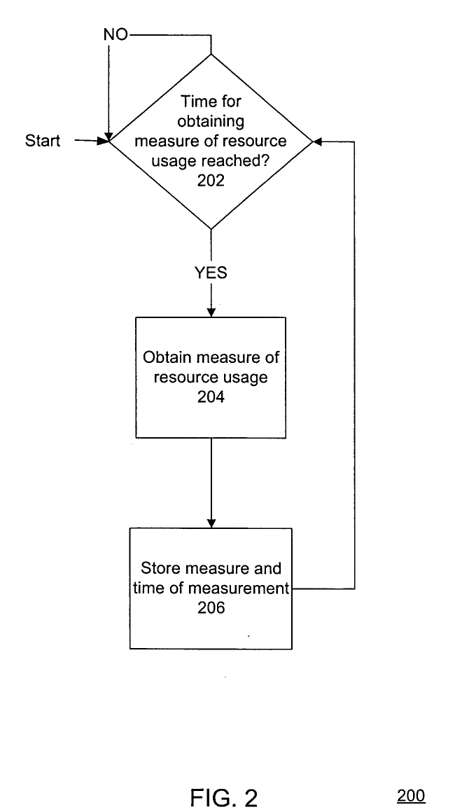

FIG. 2 is a flow chart depicting an exemplary process 200 for periodically measuring a resource usage level and storing the data in accordance with an embodiment of the invention. In an embodiment, the process 200 may be performed by the memory manager 120 in a computer system 60, and the resource usage level being measured may correspond to the used heap size. In that embodiment, the used heap size may be measured, timestamped, and stored by the memory manager, for example, after every garbage collection by the memory manager. In other embodiments, the process may be performed by other software and the resource may not relate to available memory. Other available resources in a computer system to which embodiments of the present invention may be applied include, for example, data storage space in a hard disk or other data storage system, file descriptors, socket port numbers, database connections, or other entities that are manipulated by computer programs.

As depicted in FIG. 2, the process may be configured to wait (202) until a periodic time is reached. When the periodic time is reached, then a measure of the resource usage is obtained (204). For example, the measure of the used resource may be received from the automatic resource management system, or may be received from a resource counter utility when no automatic resource management system is used. For a further example, if the resource at issue comprises the available memory for programs at runtime under an automatic memory management system, then the measured value obtained may relate to the current size of the heap after garbage collection.

The measure of the used resource and a timestamp of when the measure was taken is then stored (206). The process 200 may then loop back and wait (202) for the next periodic time to be reached.

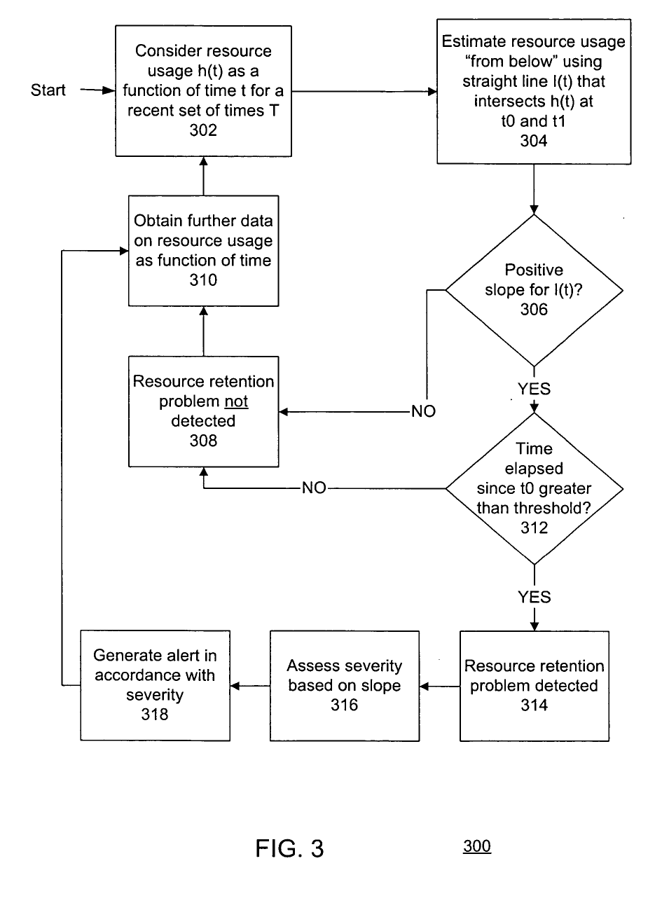

FIG. 3 is a flow chart depicting an exemplary method 300 of generating an automated alert regarding a resource retention problem in accordance with an embodiment of the invention. Generating the alert is automated in that it does not require a user to monitor the system and generate the alert manually. Instead, the system is able to generate the alert without human intervention by analyzing the resource usage data.

This method 300 shows how the resource usage data is analyzed in an automated technique to determine the existence of a problem. In an exemplary implementation, the process 200 may be performed by the memory manager 120 in a computer system 60.

Per FIG. 3, data regarding the resource usage h(t) as a function of time t for a recent set of times T is considered (302). In one example, if the resource at issue comprises the available memory for programs at runtime in a computer system with automatic memory management, then the function h(t) may represent the heap size after garbage collection at various times t. Ways to determine the heap size after garbage collection are known to those of skill in the art.

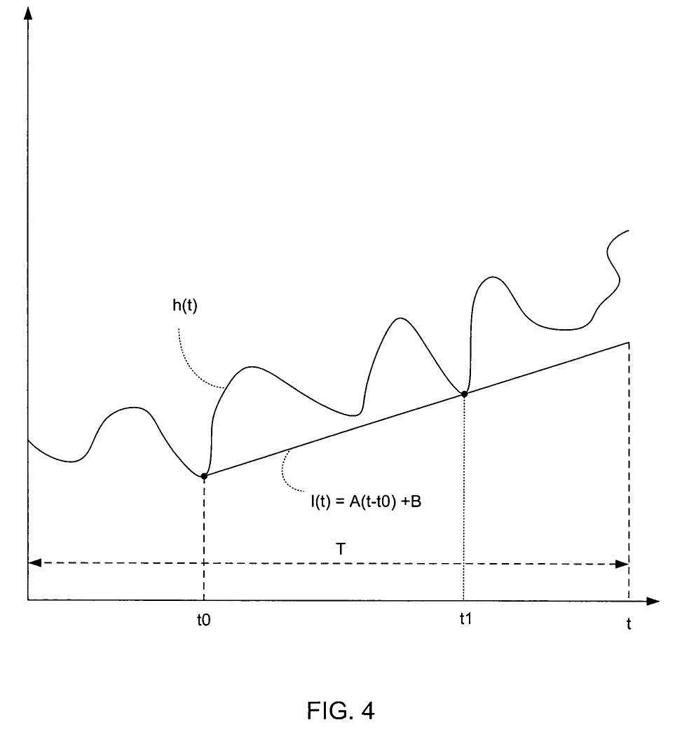

The data is analyzed or processed (304) to effectively estimate the resource usage “from below” using a straight line. In other words, a line is fit to local minima in the resource usage data. For example, the analysis finds a straight line l(t)=A(t−t0)+B that satisfies the following conditions. First, h(t0)=l(t0), and h(t1)=l(t1), where t1>t0. Second, h(t) is greater than or equal to l(t) for all t greater than t0. In other words, the linear function l(t) intersects the resource usage function h(t) at two points t0 and t1, where l(t) is less than or equal to h(t) for all times t after t0. Illustrative example of this analysis procedure is shown in FIG. 4. The above-discussed analysis may be implemented using numerical analysis techniques that are known to those of skill in the art.

FIG. 4 is a chart depicting a hypothetical resource usage function h(t) over a set of times T that is analyzed to determine the linear function l(t) that satisfies the above-described conditions. In the example shown in FIG. 4, resource usage function h(t) exhibits a tendency of its local minima [for example, h(t0) and h(t1)] to have higher values with time, such that the slope A of the linear function l(t) is positive (greater than zero). Such a positive slope to the linear function l(t) indicates the trend that an increasing amount of resources are being retained (i.e., reserved by a component of the system for a substantially non-temporary period) as time goes on. This is indicative of a resource retention problem.

Once the line (or lines) l(t) is found, then a determination is made (306) as to whether the slope A of l(t) is positive. If the slope A is zero or negative, then the method 300 determines that a resource retention problem (such as, for example, a memory leak) is not detected (308) at this time. This is because a negative slope to the linear function l(t) indicates the trend that a decreasing amount of resources are being retained as time goes on, and a zero slope to the linear function l(t) indicates the trend that a same amount of resources are being retained as time goes on. In that case, further data on the resource usage as a function of time is obtained (310). In other words, the resource usage data is updated, for example, by way of the process 200 in FIG. 2. Subsequently, the method 300 loops back to re-consider (302) the updated data.

On the other hand, if the slope A is positive, then the method 300 makes a further determination (312) as to whether the time elapsed since t0 is greater than a threshold value C. The threshold value C comprises a tunable parameter of the method 300. The greater the threshold value C, the greater the time that must elapse in order for a resource retention problem to be positively identified. If the time elapsed since t0 is not greater than the threshold C, then the method 300 determines that a resource retention problem (such as, for example, a memory leak) is not detected (308) at this time. In that case, further data on the resource usage as a function of time is obtained (310), and the method 300 loops back to re-consider (302) the updated data.

On the other hand, if the time elapsed since t0 is greater than the tunable threshold time period C, then the method 300 has detected (314) a resource retention problem. This is because h(t) has stayed at or above the positive sloping line l(t) for a sufficiently long enough time (i.e., for at least as long as the threshold time period C), and so this confirms the problematic trend that the retained resource level is increasing over time.

In accordance with an embodiment of the invention, when a resource retention problem is positively identified as discussed above, the method 300 may further make an assessment (316) of the severity of the problem based on the magnitude of the slope A of the linear function l(t). The greater the magnitude of the slope A, the greater the severity of the problem. This is because a higher magnitude slope A indicates a more rapid increase in the retained resource level. Action may then be taken (318) based on the level of severity. For example, if the resource retention problem relates to memory leakage, then the action taken may include determining the “memory leak rate” from the slope A, calculating the expected time when the heap would completely fill, and including such information when alerting an operator as to the memory leakage problem.

The new technique discussed above does not necessarily require intrusive code instrumentation and so may advantageously use a minimal amount of system resources. The technique is not dependent on the particular structure of the resource used, and so may advantageously be applied to other resource usage problems. Furthermore, the technique advantageously does not require involvement of a human operator in the assessment of the monitoring data. Not only can the technique provide automatic alerts for resource retention problems, but it can also estimate the remaining lifetime left for the system or application before it runs out of that resource. This remaining lifetime estimate (i.e. an estimate of the time left before depletion of the available resource) is determinable based on the slope of the fitted line l(t). The amount of unretained resources left may be divided by the slope to calculate a rough estimate of the remaining lifetime. With such information, adverse consequences (such as forced premature termination) can be avoided. For example, being informed that a resource (such as memory, for example) is getting low and will run out in approximately 30 minutes, a human operator can perform orderly terminations of applications and avoid forced premature terminations by the system.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of automated alerts for resource retention problems, the method comprising:
obtaining data on the resource usage as a function of time;
performing an automated analysis of the resource usage data to determine whether the data indicates a minimum level of retention of the resource that increases over time for a period of time longer than a threshold time period; and
providing an alert notification if the analysis determines that said indication is inferred from the data.

2. The method of claim 1, wherein the resource usage data is obtained periodically.

3. The method of claim 1, wherein the automated analysis includes determining a linear function.

4. The method of claim 3, wherein the linear function intersects the resource usage data at a first time and at a second time, wherein the first time is before the second time.

5. The method of claim 4, wherein the linear function is lower than the resource usage data for all times after the first time.

6. The method of claim 5, wherein said indication is determined to be present if (a) the linear function has a positive slope, such that the linear function increases with time, and (b) time elapsed since the first time is greater than the threshold time period.

7. The method of claim 6, wherein, if the analysis determines that said indication is present in the data, then further comprising:
determining a severity of the resource retention problem depending on the slope of the linear function.

8. The method of claim 7, wherein an estimated lifetime before depletion of the resource is determined by dividing an amount of unretained resources by the slope of the linear function.

9. The method of claim 1, wherein the alert notification notifies a user as to an estimated time before unavailability of the resource.

10. The method of claim 1, wherein the threshold time period is tunable by a user.

11. The method of claim 1, wherein the resource comprises available memory for programs at runtime.

12. The method of claim 11, wherein the data on the resource usage comprises a size of a memory heap.

13. The method of claim 12, wherein the data is obtained after garbage collection by an automated memory manager.

14. The method of claim 1, wherein the resource comprises a resource of a computer system.

15. An apparatus providing automated alerts for resource retention problems, the apparatus comprising:
computer-readable code configured to obtain data on the resource usage as a function of time;
computer-readable code configured to perform an automated analysis of the resource usage data to determine whether the data indicates a minimum level of retention of the resource that increases over time for a period of time longer than a threshold time period; and
computer-readable code to provide an alert notification if the analysis determines that said indication is present in the data.

16. The apparatus of claim 15, wherein the automated analysis includes determining a linear function.

17. The apparatus of claim 16, wherein the linear function intersects the resource usage data at a first time and at a second time after the first time, and wherein the linear function is lower than the resource usage data for all times after the first time.

18. The apparatus of claim 17, wherein said indication is determined to be present if (a) the linear function has a positive slope, such that the linear function increases with time, and (b) time elapsed since the first time is greater than the threshold time period.

19. The apparatus of claim 18, wherein, if the analysis determines that said indication is present in the data, then further comprising:
determining a severity of the resource retention problem depending on the slope of the linear function.

20. The apparatus of claim 18, wherein an estimated lifetime before depletion of the resource is determined by dividing an amount of unretained resources by the slope of the linear function.

21. The apparatus of claim 15, wherein the resource comprises available memory for programs at runtime, and wherein the data on the resource usage comprises a size of a memory heap.
